(19) United States
(12) Patent Application Publication
(10) Pub. No.: US 2020/0080362 A1
(43) Pub. Date: Mar. 12, 2020

(54) METHOD AND SYSTEM FOR FILLING GAP IN FENESTRATION THRESHOLD

(71) Applicant: Westhampton Architectural Glass, Inc., Speonk, NY (US)

(72) Inventors: Paul T. SILLER, Remsenburg, NY (US); Robert B. BUSKING, JR., Remsenburg, NY (US)

(73) Assignee: Westhampton Architectural Glass, Inc., Speonk, NY (US)

(21) Appl. No.: 16/565,374

(22) Filed: Sep. 9, 2019

Related U.S. Application Data
(60) Provisional application No. 62/729,080, filed on Sep. 10, 2018.

(51) Int. Cl. E06B 1/70; E06B 3/46

(52) U.S. Cl. CPC E06B 1/70; E06B 3/4636

(57) ABSTRACT

A method for filling a threshold gap in a floor of a fenestration can include translating a fenestration member along the threshold of the fenestration, actuating a threshold filling assembly in response to translation of the fenestration member, and moving a threshold filler with the filling assembly into the gap to fill the gap. A fenestration threshold filling assembly can include a filling component sized to fit a gap in a fenestration threshold, a support connected to the filling component, and an assembly configured to move the support between a retracted position and an extended position.

### INTRODUCTION

The present disclosure relates to constructions for doors, windows, or other fenestration members, and more particularly, to a door threshold filling system and method.

In sliding door systems, the door slides along a rail disposed along a threshold. Conventional rails are generally made of a different material than a surrounding floor material. The conventional rail system leaves an uneven surface along the floor which may present a tripping hazard.

### SUMMARY

In accordance with the present disclosure, a fenestration threshold filling system, including a fenestration member, a filling component sized to fit a gap in a fenestration threshold; a support connected to the filling component; and an assembly configured to move the support between a retracted position and an extended position is provided.

According to the present disclosure, a fenestration assembly including a track assembly is provided. The fenestration assembly can also include a fenestration support member having an upper portion for supporting a fenestration member and a lower portion configured to be moved with a carriage assembly disposed in the fenestration support member below a floor, wherein the upper and lower fenestration support members are connected by a connecting portion configured to extend through a gap in the floor. The fenestration assembly can also include a carriage assembly disposed in the fenestration support member, the carriage configured to engage the track assembly. The fenestration assembly can also include a threshold filler configured to fill the gap in the floor in response to the fenestration support member traversing along the track assembly.

According to another aspect of the present disclosure, a method of filling a threshold gap in a floor of a fenestration is provided, including translating a fenestration member along a threshold of the fenestration; actuating a threshold filling assembly in response to translation of the fenestration member; and moving a threshold filler with the threshold filling assembly into the gap to fill the gap.

According to yet another aspect of the present disclosure, a method of installing a fenestration member is provided, including disposing a track assembly below a floor; pivotably coupling a threshold filler and associated support member to the track assembly; disposing a fenestration support member having a carriage assembly below the floor; and engaging a track assembly via the carriage assembly, where a connecting portion of fenestration support member extends through a gap in the floor.

### BRIEF DESCRIPTION OF DRAWINGS

FIG. 1 is a diagram of a threshold filling system with the filler material in a lowered position, according to an embodiment.

FIG. 2 is a perspective view diagram of an exemplary embodiment of a threshold filling system with the filler material extended in a vertical position according to the present disclosure.

FIG. 3 is an extended view of the system of FIG. 2.

Throughout the drawings and the detailed description, the same reference numerals refer to the same elements. The scale and proportions of elements depicted in the drawings are illustrative and non-limiting.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent from the disclosure of this application. The embodiments described herein are merely examples, and are not limited to those set forth herein, but may be changed as will be apparent after an understanding of the disclosure of this application. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

In conventional sliding door systems, the door slides on a support system that moves within a track defined by a gap in the threshold between floor portions on either side of the door. For example, the threshold may be between an interior floor and an exterior floor. As the door moves from a closed position to an open position on the track, the gap in the threshold is exposed and remains open. This open gap is a tripping hazard. For example, the heel of a high-heeled shoe may become wedged into or otherwise caught within the gap or catch on an edge of the gap, causing the wearer to stumble or fall.

In accordance with the present disclosure, a system and method for filling the gap within the threshold as the sliding door moves from the open to closed position is provided. In accordance with one aspect of the disclosure, a filler material is mounted on a platform and the platform is actuated to move between a recessed position and an extended position in response to movement of the sliding door. In the recessed position, the filler material and platform rest below the floor and/or threshold upon which the sliding door is supported. In the extended position, the filler material is substantially coplanar with the floor. The platform may be actuated automatically by movement of the sliding door. The filler material may be held in place when reaching the extended position, thereby preventing the filler material from dropping or recessing in response to being stepped on by a person.

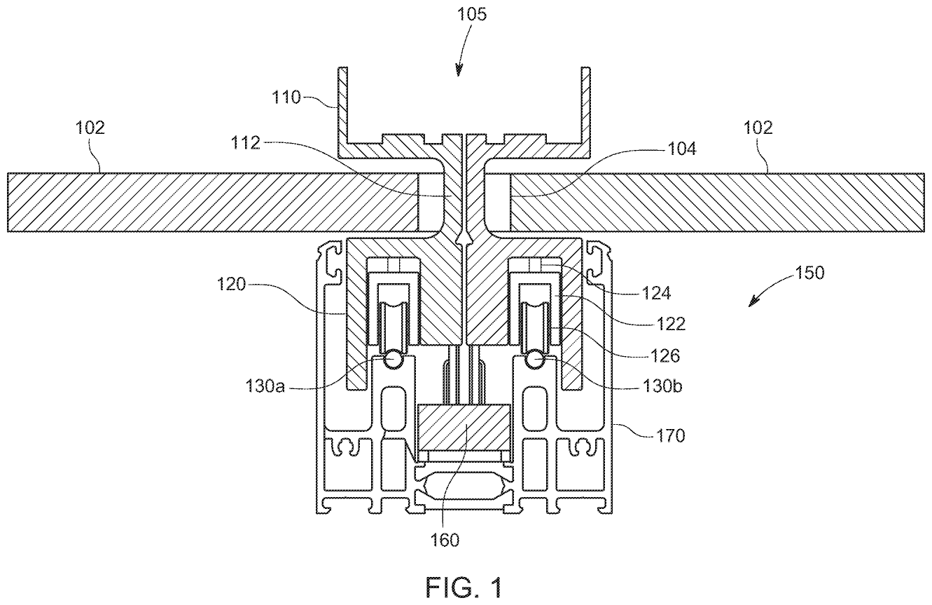

FIG. 1 shows an exemplary embodiment of a sliding fenestration member, e.g., a door or window, which includes a track assembly 150 mounted below a finished floor or wall 102. For example purposes only, the fenestration member is described in terms of a sliding door (the door itself is not shown, but is configured to sit within an upper yoke 110). However, the disclosed system can be used in any system that includes a fenestration member that slides along a threshold. The door travels along tracks 130 of the track assembly 150. The fenestration member rides on the tracks 130 via a yoke assembly 105 comprising first and second yokes 110, 120 and a connecting portion 112. The first and second yokes 110, 120 of the yoke assembly are positioned above and below the floor 102, respectively, and are connected to one another through a connecting portion 112 that extends through a gap 104 in the floor 102. As discussed above, the gap 104 in the floor 102 may be considered a threshold between the floor 102 on a first side of the door or window and the floor on a second side of the door or window.

The first yoke 110 is disposed exterior to the finished floor or wall 102 and is configured to couple to and support the door. The second yoke 120 is disposed below the finished floor or within a finished wall 102. The first and second yokes 110, 120 are connected to each other through a connecting portion 112. The connecting portion 112 extends from the second yoke 120 through the gap 104 to the first yoke 110 above the floor or exterior to a wall 102. The first and second yokes 110, 120 may be vertically split (with reference to the orientation shown in FIG. 1) and coupled to each other. Additionally, the first and second yokes 110, 120 may be thermally insulated from each other to prevent the formation of a thermal path from inside the floor or wall 102 to the outside of the floor or wall 120, and from one side of the door to the opposing side of the door.

The second yoke 120 engages the track assembly 150 through a carriage assembly 122. The carriage assembly 122 comprises a plurality of wheels, rollers, or casters 126 and leveling screws 124. The leveling screws 124 may be adjusted to level the door when on the track assembly 150. The wheel material may be stainless steel, plastic, or aluminum, or any combination thereof.

The track assembly 150 is positioned below the floor portion 102 and centered to support and guide the door or window along the gap 104 and on the track 130. As illustrated, the track assembly 150 comprises a frame 170 that supports tracks 130a, 130b, the lower/second yoke 120, a carriage assembly 122 upon which the lower yoke 120 is supported, such that it moves with the carriage assembly 122, and filler positioning assembly 180. The frame 170 extends in the direction of translation of the fenestration member. The frame 170 may be made of aluminum, plastic, steel, or other material. The frame 170 is configured to hold to tracks 130. The tracks 130 may include a rod, rail, or shaft extending along the length of the sill. The tracks 130 may be rounded and solid. The track material may be stainless steel. The track assembly 150 can be disposed on a subfloor 106 disposed below the floor portion 102.

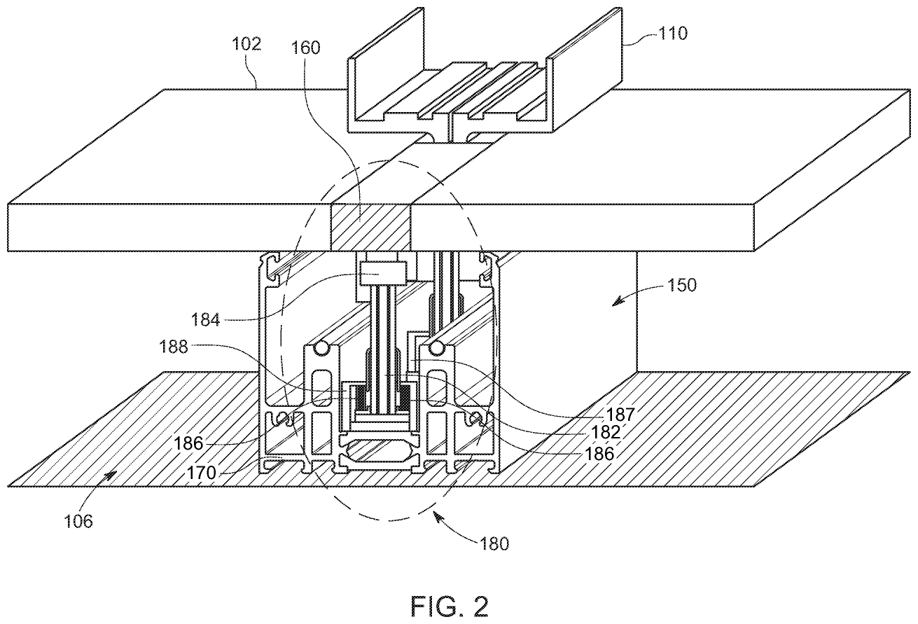

Referring to FIG. 2, the filler positioning assembly 180 comprises a filler material 160, a support member 182, springs 186, a first bracket 188 and a second bracket 187. As the fenestration member translates across the tracks 130, the filler positioning assembly 180 raises the filler material 160 into the gap 104 in the floor previously occupied by the yoke connector 112, upper yoke 110, and the fenestration member. Elastically compressible members or springs 186 connected to the support member 182 cause the support member 182 to extend towards the gap 104.

For example, the springs 186 may be torsion springs and the support member 182, e.g., a shaft or an I-beam, may be pivotably coupled to the frame 170. As a door supported by the yoke assembly translates in a linear direction, a mounting platform 184 holding the filler material 160 disposed under the carriage assembly 122 is exposed, removing a force that maintains the torsion springs in a compressed position. The compressed torsion springs can untwist forcing the connected support member 182 to rotate at a pivot. A stop at the upper bracket 187 and a stop at the lower bracket 186 limit the travel of the support member 182 to a fixed vertical position. In the vertical position of the support member 182, the filler material 160 is disposed in the gap 104 and an upper surface of the filler material is substantially coplanar with a top surface of the floor 102. The mounting platform 184 is pivotably coupled to the support member 182, thereby maintaining an orientation of the filler material 160 in an upright position as the support member 182 moves. The filler material 160 can comprise the same material as or a material having a similar appearance to a piece of the flooring that is positioned on either side of the sliding door. For example, a piece of the flooring may be disposed on the support member 184. The filler material 160 may be the same thickness of the exterior floor 102. The filler material 160 may have a width slightly less than a width of the gap 104, such that the filler material 160 can be rotated into place within gap 160 without exerting force that would be characteristic of a friction fit. However, as will be understood of those of ordinary skill in the art, use of a filler material having a width that would provide a friction fit within the gap is within the scope of the present disclosure.

In an embodiment, the filler material 160 may be, for example wood, stone, or tile, or any material of which the fenestration member jamb is made, or any combination thereof.

The filler positioning assembly 180 may further include a plurality of support members 182, springs 186, first brackets 188 and second brackets 187 spaced apart at predetermined distances to position the filler material 160 in the gap 104 as the sliding door translates. For example, as the sliding door opens, a first filler positioning assembly may raise a portion of the filler material exposed in response to the opening of the sliding door. The first filler positioning assembly may partially fill the gap with the filler material. As the sliding door translates past a second filler positioning assembly, a second support member, and the first support member may further raise the portion of the filler material exposed by the sliding door until it is coplanar with the floor.

According to another embodiment, a plurality of separate sections of filler material 160 may be disposed on a corresponding plurality of filler positioning assemblies. For example, a section of filler material 160 may be mounted to two filler positioning assemblies. The sliding door may be partially opened and an exposed section of filler material may fully extend into the gap while sections of the filler material still covered by the sliding door remain in a compressed state. In the fully extended state, an upper surface of the section of filler material is substantially coplanar with an upper surface of the floor.

In the fully extended state, the filler positioning system prevents the support member from dropping, sagging, or otherwise moving downward in the gap 104 in response to pressure on the filler material 160. For example, the springs 160 push the support member 182 of the positioning system up against the upper and lower brackets 187, 188. The spring 186 and the brackets 187, 188 hold the support member 182 vertically, e.g. 90 degrees relative to the long axis of the track (with reference to the orientation shown in FIG. 1). The vertical alignment of the support member under the filler material can prevent the filler material 160 from dropping in response to a force being applied to the filler material 160. For example, a force may be applied by a person stepping down onto the filler material 160, the force is transmitted through the filler material 160, through the support member 182 aligned in the vertical position, and applied to the bottom bracket 188 and/or track assembly 150.

The support member pivots downward in response to the fenestration member being closed. For example, as the fenestration member is closed, the second yoke 120 travels along the track 130 and engages the support member 182 thereby causing the support member 182 to rotate down and away from the gap 104, thereby lowering the filler material 160.

In one exemplary embodiment, the springs 186 may be linear springs offset from the support member 182 to cause the support member 182 to rotate in response to translation of the fenestration member.

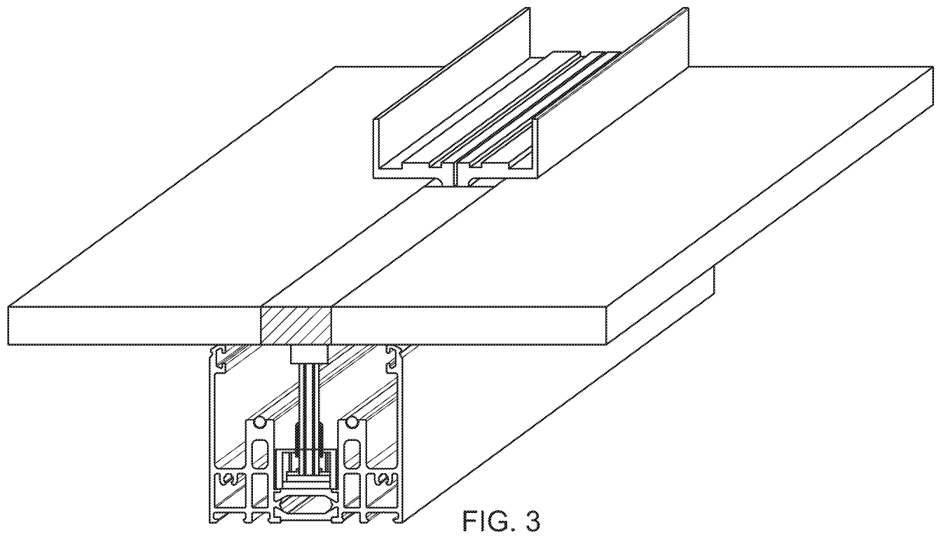

FIGS. 2 and 3 show perspective views of a fenestration member threshold filler system according to embodiments where the fenestration member is translated by different distances. In FIGS. 2 and 3 the support member 182 is extended to the vertical position thereby maintaining the filler material 160 in the gap 104.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, or device are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

We claim:

1. A fenestration threshold filling system, comprising:
a filling component sized to fit a gap in a fenestration threshold;
a support connected to the filling component; and
a positioning assembly configured to move the support between a retracted position and an extended position.

2. The system of claim 1, wherein the positioning assembly is actuatable by translation of a fenestration member along the fenestration threshold.

3. The system of claim 2, wherein actuation of the positioning assembly includes actuating a spring component of the positioning assembly.

4. The system of claim 1, wherein the retracted position is located below a surface containing the fenestration threshold.

5. The system of claim 1, wherein the extended position is substantially level with the fenestration threshold.

6. A fenestration assembly comprising:
a track assembly;
a fenestration support member having an upper portion for supporting a fenestration member and a lower portion configured to be moved with a carriage assembly disposed in the fenestration support member below a floor, wherein the upper and lower fenestration support members are connected by a connecting portion configured to extend through a gap in the floor;
a carriage assembly disposed in the fenestration support member, the carriage configured to engage the track assembly; and
a threshold filler configured to fill the gap in the floor in response to the fenestration support member traversing along the track assembly.

7. The assembly of claim 6, wherein the threshold filler comprises a filler material configured to visually match the floor.

8. The assembly of claim 7, wherein the threshold filler further comprises:
a filler support member attached to the filler material; and
a spring configured to move the filler support member between a retracted position and a raised position.

9. The assembly of claim 8, wherein the spring is a torsion spring.

10. The assembly of claim 8, wherein the filler support member is an I-beam.

11. The assembly of claim 8, wherein the filler support member further comprises a pivot at one end, the pivot coupled to the track assembly, wherein the spring is configured to rotate the filler support member about the pivot, thereby moving the filler material into the gap in the floor when the spring moves from a compressed configuration to an uncompressed configuration.

12. The assembly of claim 8, wherein the threshold filler further comprises a plurality of filler support members comprising the support member, each attached to a respective portion of the filler material.

13. The assembly of claim 6, wherein the upper portion of the fenestration support member comprises an upper yoke; and
the lower portion of the fenestration support member comprises a lower yoke.

14. The assembly of claim 6, wherein the carriage assembly comprises a plurality of rollers.

15. A method of filling a threshold gap in a floor of a fenestration, comprising:
translating a fenestration member along a threshold of the fenestration;
actuating a threshold filling assembly in response to translation of the fenestration member; and
moving a threshold filler with the threshold filling assembly into the gap to fill the gap.

16. The method of claim 15, wherein moving the threshold filler into the gap includes raising the threshold filler to a position that is substantially coplanar with the upper surface of the floor.

17. The method of claim 16, further comprising preventing the threshold filler from lowering from the raised position.

18. The method of claim 16, further comprising:
lowering the threshold filler in response to translation of the fenestration member in a second direction, opposite the first direction.

19. The method of claim 15, wherein the actuating comprises applying a force to a support member pivotably connected to a track assembly, wherein the support member rotates in response to the applied force.

20. The method of claim 19, further comprising:
limiting rotation of the support member in response to an upper surface of the threshold filler reaching a predetermined height.
